(19) United States
(12) Patent Application Publication
(10) Pub. No.: US 2004/0181997 A1
(43) Pub. Date: Sep. 23, 2004

(54) Mosquito repelling apparatus with air filtering function

(76) Inventors: Kyeong-Won Lee, Shiheung-shi (KR); Youn Hwan Kim, Cheonan-shi (KR)

Correspondence Address: MARGER JOHNSON & MCCOLLOM PC, 1030 SW MORRISON STREET, PORTLAND, OR, 97205, US

(21) Appl. No.: 10/484,090

(22) PCT Filed: Feb. 6, 2002
(86) PCT No.: PCT/KR02/00170

(30) Foreign Application Priority Data
Jul. 20, 2001 (KR) 2001/43847

(51) Int. Cl. A01M 1/06

(52) U.S. Cl. 43/139

(57) ABSTRACT

Disclosed is a mosquito repelling apparatus with an air filtering function. The mosquito repelling apparatus includes: a collecting container having an inlet, an outlet and a vacant space therein; an ultraviolet ray pylorus lamp installed at the inlet of the collecting container, for trepanning a mosquito; a collecting net installed at the outlet of collecting container; a fan installed within the collecting container such that the mosquito trepanned and killed by the ultraviolet ray pylorus lamp, is sucked into the collecting net during operation thereof; and an optical catalyst-coated layer coated on at least one surface of the collecting container. The mosquito can be killed only with the operation of the fan. The apparatus kills viruses having the mosquito as the mediator and drifting in the air, so that infection of person and domestic animal due to the viruses can be prevented.

### TECHNICAL FIELD

The present invention relates to a mosquito trap with an air cleaning capability, and more particularly, to a mosquito trap including a photo-catalyst for performing deodorization, oxidization of organic compound, and sterilization of disease-causing bacteria, by use of a photochemical reaction, as well as repelling a mosquito.

### BACKGROUND ART

Mosquitoes have a behavioral habit of being attracted by the smell of a host animal and heat or carbon dioxide generated from the host animal. Generally, there are several ways for repelling the mosquitoes, for example, a chemical repelling way using a mosquito coil or the like, a biological repelling way using loaches or the like, a physical repelling way attracting the mosquitoes by means of a mosquito-enticing lamp, carbon dioxide or the like and then applying a high voltage; and environmental repelling way improving the surrounding environment such that mosquitoeslarvae can proliferate (for instance, removing water pool).

Up to now, in order to repel the mosquitoes in a barn or garden, the physical repelling way has been widely used. However, the physical repelling way using the high voltage causes some drawbacks as follows: a person or livestock may be subject to an electric shock; the fire may be caused by sparks from the burning mosquitoes; a lot of electricity is consumed; and it gives off an offensive smell when destroying the mosquitoes. In addition, it is impossible to exterminate the mosquitoes only by killing the mosquitoes, and the reduction of damage caused by the mosquitoes is limited. Accordingly, a multipurpose mosquito repelling apparatus is needed to destroy the mosquitoes, to remove an offensive odor by improving the environment, and to exterminate the viruses.

### DETAILED DESCRIPTION OF THE INVENTION

Accordingly, the invention is designed to solve the above drawbacks contained in the related art using the high voltage, and it is an object to provide a mosquito trap with an air cleaning function capable of performing deodorization, oxidization of organic compound, and sterilization of disease-causing bacteria.

To accomplish the above object and other advantages, there is provided a mosquito trap with an air cleaning function. The mosquito trap includes: a collecting container with an inlet, an outlet, and a vacant space therein; a mosquitoes-enticing lamp with ultraviolet ray installed at the inlet of the collecting container, for attracting a mosquito; a collecting net installed at the outlet of the collecting container; a fan installed within the collecting container so that the mosquitoes attracted by the ultraviolet ray mosquito-enticing lamp are sucked into the collecting net during operation thereof; and a photo-catalyst layer coated on at least one surface of the collecting container.

Preferably, the ultraviolet ray mosquito-enticing lamp comprises an ultraviolet ray lamp having a wavelength ranged from 300 nm to 400 nm.

The collecting container may be provided at the inlet thereof with a carbon dioxide generating device for spraying carbon dioxide on the inlet of the collecting container for better performance.

The optical catalyst-coated layer is desirable to be a TiO₂ coating layer.

Wires can be attached in the inside of the collecting container in such a way that the wires are spaced apart from each other at a desired interval on an upper or lower portion of the fan, and they may be supplied with a voltage from an external power source.

### BRIEF DESCRIPTION OF THE DRAWINGS

FIGS. 1a and 1b are exploded perspective views illustrating the structure of a mosquito trap with an air cleaning function according to the present invention

### BEST MODE FOR CARRYING OUT THE INVENTION

Hereinafter, there is described a preferred embodiment of the present invention with reference to the accompanying drawings in detail.

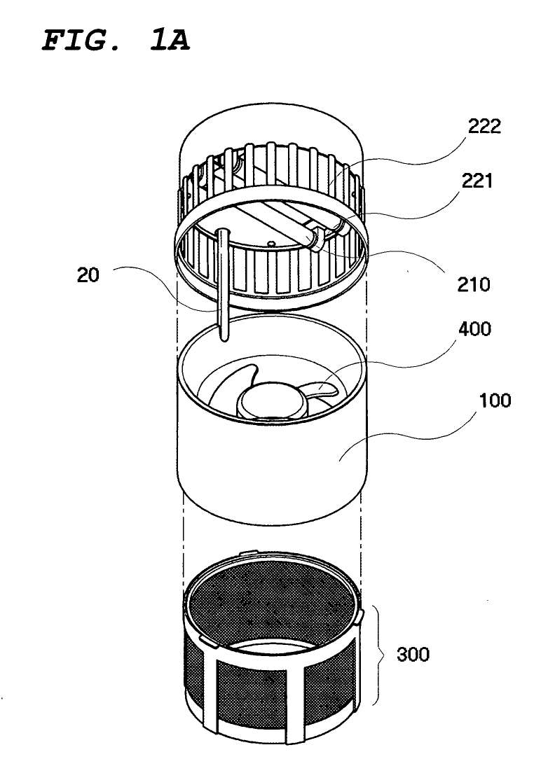

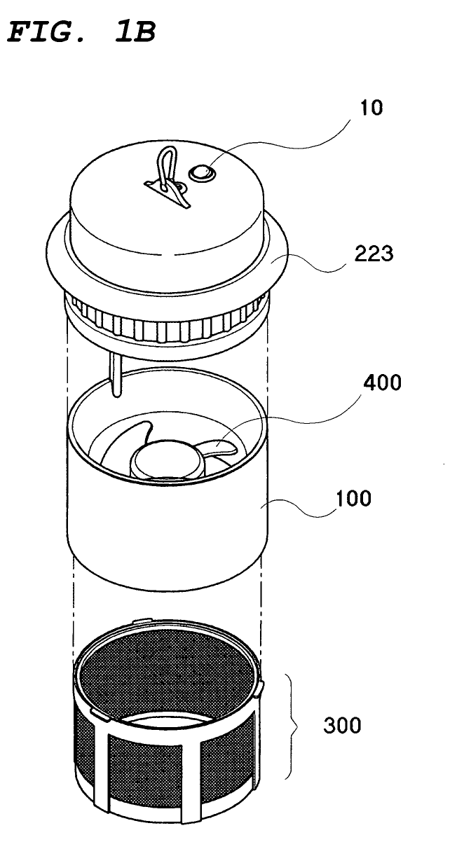

Referring to FIGS. 1a and 1b, a mosquito trap according to the present invention comprises a collecting container 100, a fan 400, an ultraviolet ray mosquito-enticing lamp 210, a collecting net 300, and a photo catalyst-coated layer (not shown).

The collecting container 100 includes an inlet and an outlet, and is provided with a tapered portion that becomes gradually narrower towards the outlet, in other words, an outside diameter of the collecting container is shorter than an inside diameter thereof.

An ultraviolet ray lamp having a wavelength of 300 nm to 400 nm which mosquitoes like, is used as the ultraviolet ray mosquito-enticing lamp 210. The lamp includes a body having a lamp seat 221 for maintaining a spaced distance between the ultraviolet ray mosquito-enticing lamp 210 and the inlet of the collecting container 100 when the body is engaged to the collecting container, and grids 222, provided between the lamp body seat 221 and the collecting container 100, for radiating the ultraviolet ray and receiving the mosquitoes. Preferably, in order to prevent rainwater from inflowing into the collecting container 100 through the grids 222, a collar 223 is provided on an upper portion of the grids 222. The lamp body is detachably installed in the inlet of the collecting container 100.

The collecting net 300 is detachably and forcefully fitted into the outlet of the collecting container 100.

The fan 400 is installed within the collecting container 100 so that the mosquitoes attracted by the ultraviolet ray mosquito-enticing lamp 210 is sucked into the collecting net 300. Accordingly, the mosquitoes attracted by the ultraviolet ray mosquito-enticing lamp 210 are destroyed in the course of inflowing into the collecting net 300 by the fan 400. At that time, because of providing the inside of the collecting container 100 with the tapered portion, the sucking force of the fan 400 is concentrated. If a switch 10 installed on an outside of the body is turned on, the fan 400 is applied with an electric current via a cable 20 located within the body and the collecting container 100.

If the collecting net 300 is filled with the destroyed mosquitoes, the collecting net 300 is detached from the collecting container 100, and then is emptied.

The inside of the collecting container 100 is coated with a layer coated with TiO₂ as a photo-catalyst. If the ultraviolet ray having a wavelength of 300 to 400 nm is radiated onto the TiO₂ coated layer by the ultraviolet ray mosquito-enticing lamp 210, a photochemical reaction occurs within the TiO₂ coated layer and then hydrated radical (OH—) is generated) The organic compounds, such as dusts and oil around the collecting container 100 and the by-product produced from the mosquitoes as killed by the fan 400) are oxidized and resolved into H₂O and CO₂ by powerful oxidizing power of the hydrated radical generated by the photochemical reaction. Disease-causing bacterium floating in the air are also destroyed. The TiO₂ coated layer is not transformed during the photochemical reaction, and the reaction is continued while the ultraviolet ray is radiated.

In addition, the photochemical reaction may remove the offensive odor produced at the stable or daily life, and the carbon dioxide generated when the hydrated radical oxidizes the organic compound is used as a lure for attracting the mosquitoes into the mosquitoes repelling apparatus according to the present invention.

Although TiO₂ is used as the photo catalyst herein, it is not limited thereto. For example, ZrO₂, ZnO, SnO₂, CeO₂, WO₂, FeO₃ or the like may be used. The photo catalyst-coated layer may be coated on an exterior wall of the collecting container 100, the body of the lamp, and the surface of the fan 400 to facilitate the photochemical reaction by the ultraviolet ray which is radiated from the sun's beam or lamps used in the daily life.

Preferably, the collecting container 100 may be provided at its inlet with a carbon dioxide generating device for spraying carbon dioxide on the inlet of the collecting container, so that much many mosquitoes can be attracted. In addition, it is preferable to provide the collecting container with electro-shock device for destroying the mosquitoes attracted in the collecting container. The electro-shock device may be located on an upper or lower portion of the fan, and includes iron wires (not shown) which are provided within the collecting container in such a manner that the wires are spaced apart from each other at a desired interval. The wires are connected to an external power source so that a voltage is applied to the wires.

### Industrial Applicability

As described previously, the mosquito trap with an air cleaning function according to the present invention includes the ultraviolet ray mosquito-enticing lamp, the fan, and the optical catalyst-coated layer, so that the mosquitoes are attracted and killed only by the operation of the fan, thereby solving the drawbacks contained in the prior mosquito trap using the high voltage. The apparatus sterilizes viruses drifting in the air, using the mosquitoes as media by use of the photochemical reaction of the photo catalyst, so that infection of person and domestic animal due to the viruses can be prevented.

In addition, the photochemical reaction happened by exposing the optical catalyst with the ultraviolet ray can remove the offensive odor produced at the stable or daily life. The carbon dioxide generated when the hydrated radical oxidizes the organic compound is used as a lure for attracting the mosquito into the mosquito trap according to the present invention, thereby effectively attracting and destroying the mosquitoes compared to the related art.

While the present invention has been described in detail with reference to the preferred embodiment, those skilled in the art will appreciate that various modifications and substitutions can be made thereto without departing from the spirit and scope of the present invention-as set forth in the appended claims.

1. A mosquito trap with an air cleaning capability, the mosquito trap comprising:
a collecting container having an inlet, an outlet, and a vacant space therein;
an ultraviolet ray mosquito-enticing lamp installed at the inlet of the collecting container, for attracting a mosquitoes;
a collecting net installed at the outlet of the collecting container;
a fan installed within the collecting container so that the mosquitoes attracted and killed by the ultraviolet ray mosquito-enticing lamp, is sucked into the collecting net during operation thereof; and
a photo catalyst-coated layer coated on at least one surface of the collecting container.

2. The mosquito trap of claim 1, wherein the ultraviolet ray mosquito-enticing lamp comprises an ultraviolet ray lamp having a wavelength ranged from 300 nm to 400 nm.

3. The mosquito trap of claim 1, further comprising, at the inlet of the collecting container, a carbon dioxide generating device for spraying carbon dioxide on the inlet of the collecting container.

4. The mosquito trap of claim 1, wherein the photo catalyst-coated layer comprises a TiO₂ coating layer.

5. The mosquito trap of claim 1, wherein the collecting container has a tapered portion so that an outer diameter of the collecting container is shorter than an inner diameter thereof.

6. The mosquito trap of claim 1, further comprising wires provided within the collecting container so that the wires are spaced apart from each other at a desired interval on an upper or lower portion of the fan, and are applied with a voltage from an external power source.
